(19) United States
(12) Patent Application Publication
(10) Pub. No.: US 2025/0094344 A1
(43) Pub. Date: Mar. 20, 2025

(54) CHAINED MAPPING WITH COMPRESSION

(71) Applicant: Micron Technology, Inc., Boise, ID (US)

(72) Inventors: Rishabh Dubey, Agrate Brianza (IT); Marco Sforzin, Cernusco Sul Naviglio MI (IT); Emanuele Confalonieri, Segrate (IT); Danilo Caraccio, Milano (IT); Daniele Balluchi, Cernusco Sul Naviglio MI (IT); Nicola Del Gatto, Cassina de' Pecchi (MI) (IT)

(21) Appl. No.: 18/782,380

(22) Filed: Jul. 24, 2024

(30) Foreign Application Priority Data
Sep. 18, 2023 (IN) 202311062640

(51) Int. Cl. G06F 12/02; G06F 13/16

(52) U.S. Cl. CPC G06F 12/0292; G06F 12/0246; G06F 13/1668

(57) ABSTRACT

A variety of applications can include a memory device having chained mapping with compression of received data. The memory device can include a mapping table having an entry location to associate a virtual page with a physical address of a first stripe of compressed data of the virtual page. A controller of the memory device, responsive to the data of the virtual page being compressed data, can load information about a second stripe of the compressed data into extra locations in the first stripe different from locations for compressed data of the virtual page in the first stripe. Additional apparatus, systems, and methods are disclosed.

### PRIORITY APPLICATION

This application claims the benefit of priority to Indian Patent Application number 202311062640, filed Sep. 18, 2023, which is incorporated herein by reference in its entirety.

### FIELD OF THE DISCLOSURE

Embodiments of the disclosure relate generally to electronic devices and, more specifically, to storage memory devices and operation thereof.

### BACKGROUND

Memory devices are typically provided as internal, semiconductor, integrated circuits in computers or other electronic devices in a variety of manufactured products. There are many different types of memory, including volatile and non-volatile memory. Volatile memory requires power to maintain its data, and examples of volatile memory include random-access memory (RAM), dynamic random-access memory (DRAM), static RAM (SRAM), and synchronous dynamic random-access memory (SDRAM), among others. Non-volatile memory can retain stored data when not powered, and examples of non-volatile memory include flash memory, read-only memory (ROM), electrically erasable programmable ROM (EEPROM), erasable programmable ROM (EPROM), resistance variable memory, such as phase-change random-access memory (PCRAM), resistive random-access memory (RRAM), magnetoresistive random-access memory (MRAM), and three-dimensional (3D) XPoint™ memory, among others.

The various types of memories can be used in applications in which manufacturers of consumer products use architectures for memory devices, which architectures can include one or more memory subsystems having multiple individual storage memory medium in which the memory device interacts with a host device to store user data in the one or more memory subsystems of the memory device. The host device and the memory devices can operate using one or more protocols that can include standardized protocols. Operation and properties of memory devices and other electronic devices in systems can be improved by enhancements to the procedures and design of these electronic devices for their introduction into the systems for which the electronic devices are intended.

### BRIEF DESCRIPTION OF THE DRAWINGS

The drawings, which are not necessarily drawn to scale, illustrate generally, by way of example, but not by way of limitation, various embodiments discussed in the present document.

FIG. 1 is a representation of a relationship between a mapping table translating virtual pages from a host to data stripes of a memory device that can be implemented with the virtual pages compressed, according to various embodiments.

FIG. 2 illustrates a representation of data of a virtual page stored in a number of stripes of the memory media of a memory device, where the data is compressed data, according to various embodiments.

FIG. 3 illustrates a representation of a chain mapping scheme implemented by a linear table that has a single entry for the compressed data of a given virtual page in temporary storage of a memory device, where the single entry contains an index of the physical address of a first stripe of the compressed data of the given virtual page, according to various embodiments.

FIG. 4 is a flow diagram of features of an example method of reading data from a memory device, with the data being stored in the memory device as compressed data, according to various embodiments.

FIG. 5 is a flow diagram of features of an example method of writing data to a memory device, with the data being stored in the memory device as compressed data, according to various embodiments.

FIG. 6 illustrates a block diagram of example component features of a compute express link system that includes a chained mapping scheme with compression of user data, according to various embodiments.

FIG. 7 illustrates an example of the compress region manager of the compute express link controller of FIG. 6, according to various embodiments.

FIG. 8 illustrates an embodiment of an example of the table manager of the compress region manager of FIG. 7, according to various embodiments.

FIG. 9 is a block diagram of an example system including a host that operates with a memory device having one or more memory media, where the memory device can implement a chained mapping scheme with compression of user data, according to various embodiments.

### DETAILED DESCRIPTION

The following detailed description refers to the accompanying drawings that show, by way of illustration and not limitation, various embodiments in which an invention can be practiced. These embodiments are described in sufficient detail to enable those skilled in the art to practice these and other embodiments. Other embodiments may be utilized, and structural, logical, mechanical, and electrical changes may be made to these embodiments. The various embodiments are not necessarily mutually exclusive, as some embodiments can be combined with one or more other embodiments to form new embodiments. The following detailed description is, therefore, not to be taken in a limiting sense.

To improve physical space utilization in a memory device, a data compression feature may be implemented in the memory device to compress data received from a host. The memory device can include one or more memory media to store user data. This feature can be structured to compress data while writing the host data and decompress compressed data while reading in response to a host read request. The compression of user data can change the target capacity of the memory device and provide better physical capacity utilization compared to memory devices without compression. The compression can be characterized by a compression ratio, which compression ratio can depend on the nature of the block of data used as the basis for storing data in the memory device. Compression can be used to change the data block size for the data being stored. For an example unit block size of 4096 bytes, referred to as 4K bytes (4 KB), a compression can result in storing the data in units between a few bytes to 4 KB. In a conventional approach, an additional indirection would be used to locate the data blocks in the memory media of the memory device after compression.

The memory device can be realized in a number of different memory device architectures. For example, the compression can be conducted in, but is not limited to, a compute express link (CXL) memory device, a solid-state drive (SSD), or other memory device. One or more memory devices may be coupled to a host, for example, a host computing device to store data, commands, and/or instructions for use by the host while the computer or electronic system is operating. Data, commands, or instructions can be transferred between the host and the one or more memory devices during operation of a computing or other electronic system.

Various protocols or standards can be applied to facilitate communication between a host and one or more other devices such as memory devices, memory buffers, accelerators, or other input/output devices. For example, an unordered protocol such as CXL can be used to provide high-bandwidth and low-latency connectivity. Other protocols can be used alternative to or in conjunction with CXL.

CXL is an open standard interconnect configured for high-bandwidth, low-latency connectivity between host devices and other devices such as accelerators, memory buffers, and other I/O devices. CXL was designed to facilitate high-performance computational workloads by supporting heterogeneous processing and memory systems. CXL enables coherency and memory semantics on top of peripheral component interconnect express (PCIe)-based I/O semantics for optimized performance.

CXL can be used in applications such as artificial intelligence, machine learning, analytics, cloud infrastructure, edge computing devices, communication systems, and elsewhere. Data processing in such applications can use various scalar, vector, matrix, and spatial architectures that can be deployed in a central processing unit (CPU), a graphics processing unit (GPU), a field-programmable gate array (FPGA), a digital signal processors (DSP), an application-specific integrated circuit (ASIC), other programmable logic devices, smart network interface cards (NICs), or other accelerators that can be coupled using a CXL link. A processing module, such as a CPU, can be realized as a host device or host processor in the architecture in which the CPU is structured.

CXL supports dynamic multiplexing using a set of protocols that includes input/output (CXL.io, based on PCIe), caching (CXL.cache), and memory (CXL.memory) semantics. CXL can be used to maintain a unified, coherent memory space between the CPU and any memory on the attached CXL device. This configuration allows the CPU and the CXL device to share resources and operate on the same memory region for higher performance, reduced data movement, and reduced software stack complexity. In an example, the CPU can be primarily responsible for maintaining or managing coherency in a CXL environment. Accordingly, CXL can be leveraged to help reduce device cost and complexity, as well as overhead traditionally associated with coherency across an I/O link.

CXL runs on PCIe physical layer (PHY) and provides full interoperability with PCIe. A CXL device can start link training with a PCIe generation 1 data rate and can negotiate CXL as its operating protocol if its link partner supports CXL. CXL can be used as an operating protocol, for example, using an alternate protocol negotiation mechanism defined in the PCIe 5.0 specification. Devices and platforms can thus more readily adopt CXL by leveraging the PCIe infrastructure and without having to design and validate the PHY, channel, channel extension devices, or other upper layers of PCIe.

CXL technology can maintain memory coherency between the CPU memory space and memory on attached devices, which enables resource sharing for higher performance, reduces software stack complexity, and lowers overall system cost. Three primary types of devices can employ a CXL interconnect protocol. Type 1 devices can include accelerators such as smart NICs that typically lack local memory. Via CXL, these type 1 devices can communicate with memory of the host processor to which it is coupled. Type 1 devices can use CXL.io+CXL.cache protocols. Type 2 devices can include GPUs, ASICs, and FPGAs that are equipped with instrumentalities such as, but not limited to, double data rate (DDR) memory or high bandwidth memory (HBM) and can use CXL to make the memory of the host processor locally available to an accelerator and make the memory of the accelerator locally available to the host processor. The type 2 devices can also be co-located in the same cache-coherent domain and help boost heterogeneous workloads. Type 2 devices can use CXL.io+CXL.cache+CXL.memory protocols. Type 3 devices can include memory devices that can be attached via CXL to provide additional bandwidth and capacity to host processors. The type of memory is independent of the main memory of the host. Type 3 devices can use CXL.io+CXL.memory protocols.

Compression in a memory device, such as but not limited to a CXL memory device, can be implemented with a mechanism to locate blocks of data in storage media after compression. The ability to reference the data using a reference other than the value of the data itself, for example operating on the data through its memory address, is an indirection mechanism. An indirection table can contain entries that are pointers to the location or locations of the data in the storage media. A linear indirection table can be used for address translation of compressed data. A linear indirection table for a memory device can be arranged with entries for each address of a page of data provided by a host device. Such addresses and pages of data are provided by the host device independent of the management of data in the memory device. With respect to the memory device, the host-supplied addresses and pages are virtual addresses (VAs) and virtual pages (VPs), which VAs are mapped by the memory device to physical addresses (PAS). A PA is an address that the memory device uses to point to a memory medium (for example, a memory die or a packaged memory die), row, and column to store one or more bits of data, where the pointing mechanism can include a calculation dependent on the type of memory used for the memory medium.

In a memory device, a user page size can be set equal to 4 KB, with a VP structured as being equal to 64 contiguous PAs (64 B*64=4096 B (4 KB)) of the memory device. A media unit of the memory device can be defined as the smallest amount of data that can be written onto the memory device. The media unit can be set as 256 B. The media units can be referred to as stripes. For a user page size of 4 KB of user data, sixteen stripes can be used to store the user data. Other sizes for user pages and sizes for stripes can be used.

In a first conventional approach (a first option) to managing data compression in the memory device, a mapping table in the memory device can be implemented as a linear indirection table structured having one entry per user block (e.g., 4K). The entry can include a starting PA for a stripe of data in the storage media of the memory device and a count (specified number) of consecutive PAs following the starting PA to store the compressed data. Optionally, the entry for the starting PA can be an index, where the count identifies the next specified indexes. The index can be a pointer to a location in a table of stripes having PAs. This first option can provide a relatively small mapping table, but can lead to implementation of a defragmentation. Defragmentation is a process of freeing up storage space. In this first option, the defragmentation in the memory device can be challenging and complex. For example, in the first option, defragmentation can be used to create free continuous stripes of data, which may create complexity to a compression procedure.

In a second conventional option, use of defragmentation can be avoided by having an entry for each VA in a linear indirection table that includes a PA for each stripe of data written corresponding to a given VA. Optionally, the entry for the PAs associated with a given VA can be a set of indexes, where each index can point to a location in a table of stripes having a different PA for each index. However, in this second option, this indirection table is a mapping table that can have a significant increase in size as compared to the first option. For a user page size of 4 KB and a stripe size of 256 B, the mapping table size of the second option can be sixteen times the mapping table size of first option.

In various embodiments, a chained mapping scheme translating a VA to PAs in a memory storage can be implemented for data that can be compressed. The mapping table size can depend on the compression ratio of the data to be written to the memory storage. Depending on the compression ratio of the selected compression procedure, a compressible page can be compressed into a number of stripes less than the number of stripes to store data of the page in uncompressed format. If a page can be compressed, a mapping table can have the PA of a first stripe to store the compressed data of the page in the memory media of the memory device. For the compressed data of the VP in a chained mapping scheme, the mapping table for the VA of the VP can have a single entry, where the PAs of stripes other than the first stripe are stored in the physical memory of the memory media. With the compressed data of the VP stored in a series of stripes, PAs of subsequent stripes of the series are stored in extra locations of previous stripes of the series. The extra locations can be reserved bits of the physical memory of the memory media. The chained mapping scheme can be viewed as a linear table having the PA of the first stripe of the compressed data of the VP and a chaining mechanism in which next stripe information is stored in extra bits in extra bits of the current stripe.

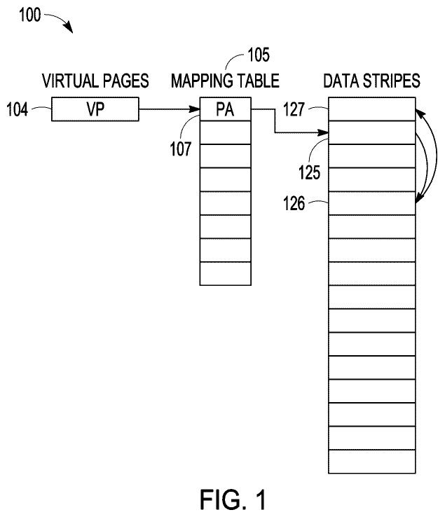

FIG. 1 is a representation 100 of a relationship between a mapping table 105 translating VPs from a host to data stripes of a memory device that can be implemented with the VPs compressed. Representation 100 shows an entry 107 of a mapping table 105 for data entry 104 of a VP corresponding to a VA. Entry 107 includes the PA of a first stripe 125 of data corresponding to the compressed data of the VP. First stripe 125 can contain the PA of the next stripe 126 of the compressed data of the VP. Next stripe 126 can contain the PA of a subsequent stripe 127 of the compressed data of the VP. Thus, in defining the stripes containing the compressed data for the VP having a VA corresponding to the PA in entry 107 of the mapping table 105, the stripes can be accessed from the chaining of PAs for the stripes within the chain of stripes. Though three stripes are shown for the chaining representation 100 of FIG. 1, the number of stripes to store compressed data of a VP can be more or fewer than three, depending on the results of the compression of the VP, the size of the user data page of the VP, and the size of a stripe used by the memory device to store data in memory media of the memory device.

With the PAs for the stripes of compressed data correlated to the VA of the VP from the single entry 107 of mapping table 105, mapping table 105 can be realized as a liner indirection table and the size of mapping table 105 can be approximately the same as the size of the linear table in the first conventional option mentioned above. However, single entry 107 of mapping table 105 does not include additional bits to identify, in mapping table 105, the count of the additional stripes to store the compressed data as is structured in the first option.

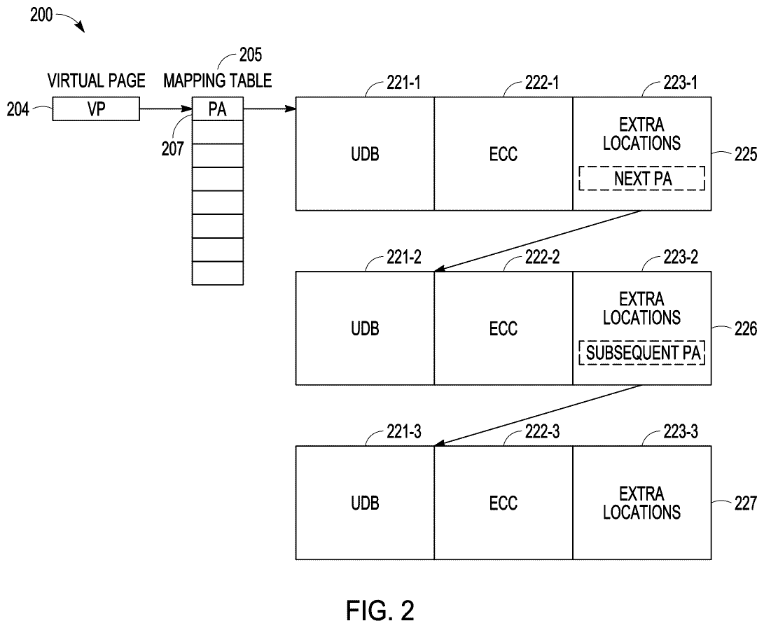

FIG. 2 illustrates a representation 200 of data of a VP stored in a number of stripes of the memory media of a memory device, where the data is compressed data. The VP from a host can be stored in one or more buffers (buffer(s)) 204 for writing to the memory media of the memory cache. Buffer(s) 204 can be realized by different structural formats that can hold or cache data for further processing. The VP has a VA that can be associated with a PA that can be stored in an entry of a mapping table 205, which can be a linear indirection table similar to mapping table 105 of FIG. 1, where the PA can be the PA of a first stripe in the physical memory of the memory media that will store data after compressing the received VP by the memory device. As shown in FIG. 2, the PA of the first stripe is stored in entry 207 of mapping table 205, and PAs of subsequent stripes are stored in extra locations in the physical memory of the memory media of the memory device. The extra locations are extra data bits of the memory media and can be reserved bits of the memory media.

Memory devices without compression support can include additional reserved bits in its memory media for storing metadata and a key identification (Key ID). Metadata is data about other data. Metadata can be structured to reference data that can be used to characterize and identify attributes of the data it describes, which data can be user data stored in the stripes of the memory media. A Key ID can be used for security to support data security. With data written with a Key ID at a particular location in the data, a scheme can be implemented to examine the particular location when reading the data in response to a read request from a host that passes a key for the read request to the memory device. If the key of the read request matches the Key ID at the particular location for the stored data requested, the memory device can send the requested data to the host or, if there is a mismatch determined in a comparison of the key to the Key ID, the requested data would not be sent to the host, that is, the requested data cannot be accessed. The Key ID can be used for encryption and decryption in the memory device. Key ID can be an optional feature in a memory device. Stripes storing data of a VP can be structured with spare bits to store metadata, the Key ID, and error correction code (ECC) along with the user data blocks (UDB) in the stripes. Since Key ID and metadata are stored at granularity of entire user data block size of the VP, the stripes of compressed data, including the Key ID and metadata, can be implemented without the Key ID and metadata in each stripe of compressed data using the complete set of spare bits typically formatted as additional reserved bits for storing the metadata and Key ID. The additional reserved bits in a stripe of compressed data of a given VP can be used to store the PA of the next stripe of a series of stripes of compressed data of the given VP. Each stripe of the series of stripes of compressed data can include the PA of the next stripe, except for the last stripe in the series. The last stripe in the series terminates the chaining of PAs defining the series of stripes.

FIG. 2 illustrates a chained mapping scheme implemented by linear table 205 that has a single entry for the compressed data of a given VP, where the single entry contains the PA of first stripe of the VP, and a chaining mechanism of storing next stripe information in the extra bits of a current stripe in the set of stripes of the compressed data of the VP. As discussed, linear table 205 includes, in entry 207, the PA of first stripe 225 of the compressed data of the VP at buffer(s) 204. First stripe 225 can include a section 221-1 for UDB, a section 222-1 for ECC, and a section 223-1 of extra locations. Other information for the data of the VP can be located in section 222-1 or section 223-1, such as, but not limited to, a cyclic redundancy check (CRC) for the data. Section 223-1 of extra locations of first stripe 225 can include the next PA of a next stripe 226.

Next stripe 226 can include a section 221-2 for UDB, a section 222-2 for ECC, and a section 223-2 of extra locations. Other information for the data of the VP can be located in section 222-2 or section 223-2, such as, but not limited to, a CRC for the data. Section 223-2 of extra locations of next stripe 226 can include the subsequent PA of a subsequent stripe 227.

Subsequent stripe 227 can include a section 221-3 for UDB, a section 222-3 for ECC, and a section 223-3 of extra locations. Other information for the data of the VP can be located in section 222-3 or section 223-3, such as, but not limited to, a CRC for the data. Section 223-3 of extra locations of subsequent stripe 227 can include the PA of another subsequent stripe if there is another subsequent stripe. If subsequent stripe 227 is the last stripe to contain compressed data of the given VP, the extra locations of subsequent stripe 227 do not include the PA of another subsequent stripe. The absence of a PA in reserved bits of a stripe, such as subsequent stripe 227, identifies the termination of the chain of PAs for the compressed data of the given VP. Alternatively, a fixed code in bits of the extra locations reserved for the PA can identify the termination of the chain of PAs for the compressed data of the given VP.

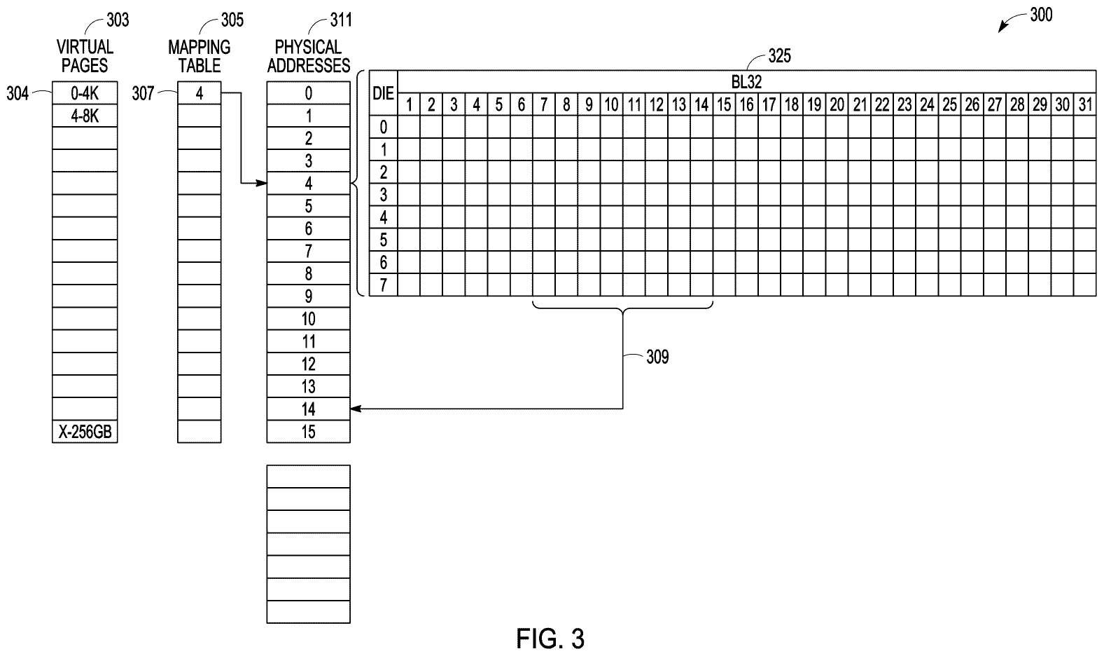

FIG. 3 illustrates a representation 300 of a chain mapping scheme implemented by linear table 305 that has a single entry for the compressed data of a given VP in temporary storage 304 of a memory device, where the single entry contains an index of the PA of a first stripe of the compressed data of the given VP. Temporary storage 304 can be buffer(s) or other similar functional structures. An entry 307 of linear table 305 can contain an index that acts as a pointer to a location of a set 311 of PAs. In this non-limiting example of FIG. 3, the VP in temporary storage 304 is one of a set 303 of VPs and has a VA corresponding to an index 4 in entry 307, where index 4 points to a location 4 in the set 311 of PAs. The PA at location 4 is the PA of a stripe 325 of compressed data. Stripe 325 of compressed data can include extra locations that can hold bits of a pointer 309 to an indexed location of the PA of a next stripe of compressed data. In this non-limiting example of FIG. 3, pointer 309 points to the indexed location 14 of set 311 of PAs. The PA at location 14 of the set 311 of PAs identifies the next stripe of compressed data that can include a pointer to determine the PA of a subsequent stripe. The chained structure uses indexes or pointers to indexes in stripes of compressed data of a given VP until the last stripe in the series of stripes for the given VP is reached.

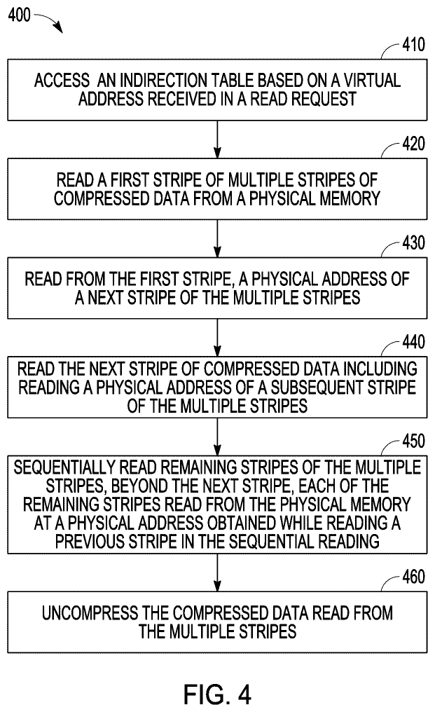

FIG. 4 is a flow diagram of features of an embodiment of an example method 400 of reading data from a memory device, with the data being stored in the memory device as compressed data. A controller of the memory device can be used to manage providing the data from compressed data and manage the read procedure. The read procedure can be managed by processing circuitry of the controller that can execute instructions stored in the memory device. The controller can be realized as one or more processing devices that can execute instructions stored in the memory device, controlling circuitry of the memory device to execute the stored instructions. At 410, an indirection table is accessed based on a VA received in a read request to the memory device from a host. The read request can be a request for one or more chunks of a complete VP of data, where each chunk has the size of a stripe of data in the memory media of the memory device. The indirection table can be accessed by loading the indirection table if the indirection table is not cached.

At 420, a first stripe of multiple stripes of compressed data is read from a physical memory of the memory device. The multiple stripes of compressed data correspond to the read request, where the first stripe is read from a PA listed in the indirection table corresponding to the VA. Each stripe of the multiple stripes can have, but is not limited to, a size of 64 bytes.

At 430, a PA of the next stripe of the multiple stripes of compressed data is read from the first stripe. At 440, the next stripe of compressed data is read from the physical memory corresponding to the PA of the next stripe, including reading a PA of a subsequent stripe of the multiple stripes of compressed data. At 450, remaining stripes of the multiple stripes, beyond the next stripe, are sequentially read. Each of the remaining stripes is read from a PA obtained while reading a previous stripe in the sequential reading. At 460, the compressed data read from the multiple stripes is uncompressed. The uncompressed data can be sent to the host.

Variations of method 400 or methods similar to method 400 can include a number of different embodiments that may be combined depending on the application of such methods and/or the architecture of systems including an electronic device in which such methods are implemented. Such methods can include placing additional read requests for data corresponding to the VA in a progress list. Variations can include, while reading the first stripe of compressed data, reading the PA of the next stripe through pins of a memory subsystem of the memory device, where the pins are used for functions different from transferring user data. These pins can be data mask inversion (DMI) pins of one or more memory media of the memory device. DMI is a dual use bi-directional signal used to indicate data to be masked, and data which is inverted on the bus. For data bus inversion (DBI), the DMI signal can be driven high when the data on the data bus is inverted, or driven low when the data is in its normal state, or vice versa depending on the architecture of the memory medium. DBI can be disabled via a mode register setting of the memory medium.

Variations of method 400 or methods similar to method 400 can include uncompressing the compressed data after all the compressed data of the multiple stripes of compressed data is read from the physical memory of the memory device. Variations can include copying uncompressed data, generated after reading the multiple stripes from the physical memory, to one or more caches of the memory device or to one or more read buffers of the memory device.

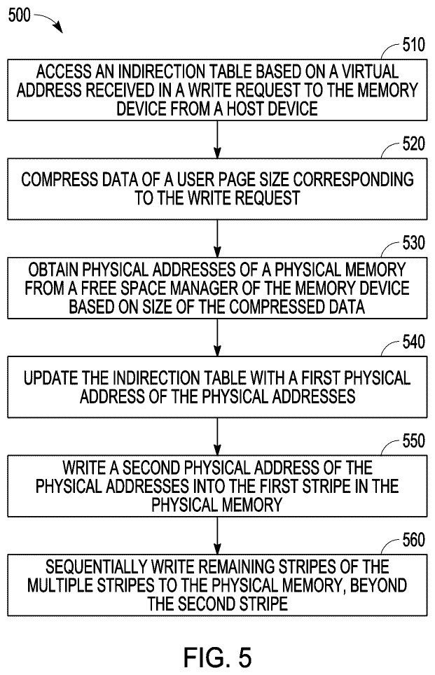

FIG. 5 is a flow diagram of features of an embodiment of an example method 500 of writing data to a memory device, with the data being stored in the memory device as compressed data. A controller of the memory device can be used to manage providing the compressed data and the write procedure. The write procedure can be managed by processing circuitry of the controller that can execute instructions stored in the memory device. The controller can be realized as one or more processing devices that can execute instructions stored in the memory device, controlling circuitry of the memory device to execute the stored instructions.

At 510, an indirection table is accessed based on a VA received in a write request to the memory device from a host device. The indirection table can be accessed by loading the indirection table for processing or can be accessed from a cache. The indirection table in the cache can include a first PA corresponding to the VA.

At 520, data of a user page size corresponding to the write request is compressed, generating compressed data. The user page size can be, but is not limited to, 4 KB. At 530, PAs of a physical memory are obtained from a free space manager of the memory device based on size of the compressed data. The PAs define locations of multiple stripes to store the compressed data in the physical memory. At 540, the indirection table is updated with a first PA of the PAs. The first PA corresponds to a first stripe of the compressed data.

At 550, a second PA of the PAs is written into the first stripe in the physical memory, the second PA corresponding to a second stripe of the compressed data. At 560, remaining stripes of the multiple stripes, beyond the second stripe, are sequentially written to the physical memory. Each of the remaining stripes contains a PA at which to write a subsequent stripe in the sequential writing until writing a last stripe of the compressed data of the VP corresponding to the VA.

Variations of method 500 or methods similar to method 500 can include a number of different embodiments that may be combined depending on the application of such methods and/or the architecture of systems including an electronic device in which such methods are implemented. Such methods can include writing the first stripe, the second stripe, and the remaining stripes into the physical memory along with a PA of a subsequent stripe of the compressed data being written by writing the PA in each stripe in reserved bit locations in each stripe. Variations can include writing the PA of a subsequent stripe in a previous stripe using pins of a memory subsystem of the memory device, where the pins are used for functions different from transferring user data. These pins can be DMI pins of one or more memory media of the memory device.

Variations of method 500 or methods similar to method 500 can include executing an invalidation procedure to free up PAs for future use. Prior to compressing the data corresponding to the write request, a PA mapped to the VA in the accessed indirection table can be passed to the free space manager. PAs of a chain of stripes associated with the PA mapped to the VA in the accessed indirection table can be obtained by the free space manager traversing through the chain and identifying a PA in each stripe of the chain other than the last stripe of the chain. In response to obtaining the PAs, the free space manager can free storage locations for future write requests.

A chained mapping scheme for memory devices as discussed herein can be implemented in a number of different applications of electronic devices. Electronic devices, such as mobile electronic devices (e.g., smart phones, tablets, etc.), electronic devices for use in automotive applications (e.g., automotive sensors, control units, driver-assistance systems, passenger safety or comfort systems, etc.), and internet-connected appliances or devices (e.g., internet-of-things (IoT) devices, etc.), have varying storage needs depending on, among other things, the type of electronic device, use environment, performance expectations, etc. Electronic devices can be broken down into several main components: a processor (e.g., a central processing unit (CPU) or other main processor); memory (e.g., one or more volatile or non-volatile random-access memory (RAM) memory device, such as DRAM, mobile or low-power double-data-rate synchronous DRAM (DDR SDRAM), etc.); and a storage device (e.g., non-volatile memory (NVM) device, such as flash memory, ROM, a SSD, a MMC, or other memory card structure or assembly, etc.). Such electronic devices can be associated with a range of architectures including a C×L system and a managed memory system, along with SSD, Universal Flash Storage (UFS™), and embedded MultiMediaCard (eMMC™) devices that can be included in a C×L system or a managed memory systems. Such electronic devices also can include processing circuitry such as one or more of memory processing devices, direct memory access (DMA) controllers, and flash memory interface circuitry to manage the access to physical memory media. Many of such electronic devices can include a user interface (e.g., a display, touch-screen, keyboard, one or more buttons, etc.), a graphics processing unit (GPU), a power management circuit, a baseband processor or one or more transceiver circuits, etc.

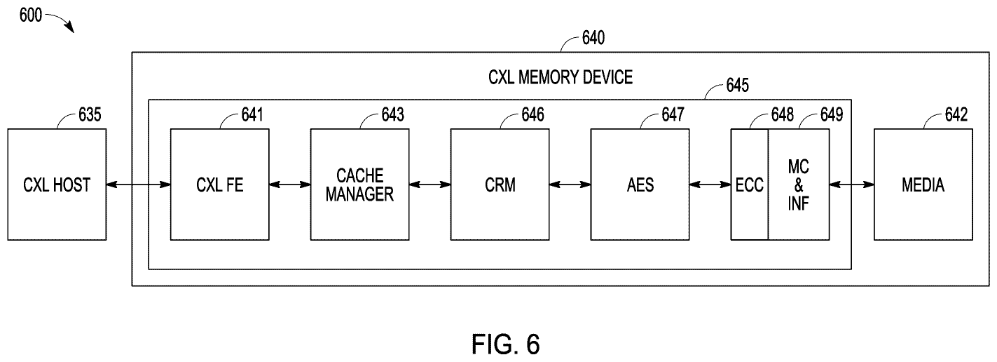

FIG. 6 is a block diagram of an embodiment of example component features of a C×L system 600 that includes chained mapping with compression of user data. C×L system 600 can include a CXL host 635 and a CXL memory device 640 that can operate in accordance with CXL protocols. CXL memory device 640 can include a controller 645 that interfaces with CXL host 635 and with media 642 of CXL memory device 640 to write user data directed from CXL host 635 to media 642 using one or more write requests and to read user data from media 642 for CXL host 635 using one or more read requests. The execution of write requests and read requests can be performed using the chained page mapping scheme with compression of user data.

Controller 645 can include a CXL front end (FE) 641 to interface with CXL host 635 using CXL protocols and a cache manager 643 to manage flow of user data associated with read and write requests received form CXL host 635. The user data can be stored in media 642, where media 642 can be structured as one or more memory structures arranged as channels of data storage. The user data can be processed with an Advanced Encryption Standard (AES) 647 and ECC 648. Processing of user data with ECC 648 by a memory controller (MC) and interface (INF) 649 that controls input and output of the user data with respect to media 642. The user data operated on by AES 647, ECC 648, and MC & INF 649 can be compressed data. Compressing user data and uncompressing user data can be controlled by a compression region manager (CRM) 646.

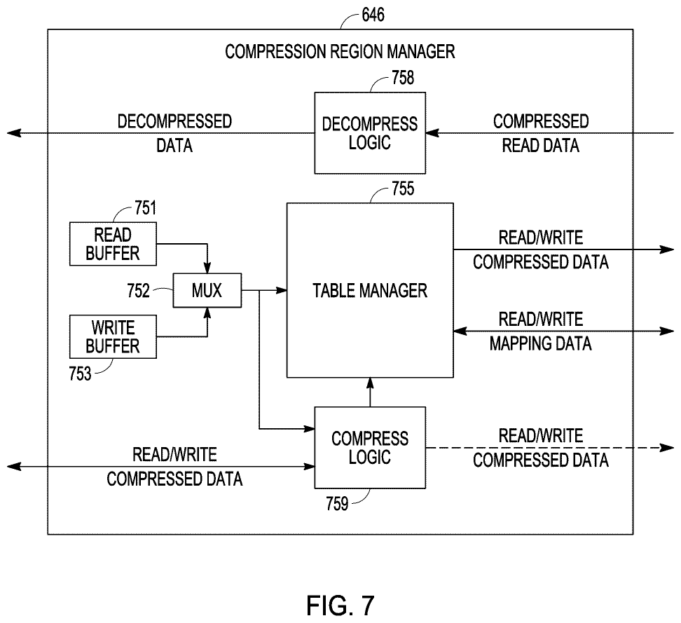

FIG. 7 illustrates an embodiment of an example of CRM 646 of CXL controller 645 of FIG. 6. CRM 646 can include a read buffer 751 to handle user data for a read request and a write buffer 753 to handle user data for a write request. Read buffer 751 and write buffer 753 can be first in, first out (FIFO) structures that can be realized in a number of formats including one or more registers or one or more other buffering structures that can cache user data. Data from read buffer 751 and write buffer 753 can be directed to a table manager 755 and compress logic 759 by a multiplexer (MUX) 752. CRM 646 also includes decompress logic 758 to uncompress, using logic circuitry within decompress logic 758, received compressed read data, where the compressed read data is compressed data from media 642 received in response to a read request. Compress logic 759 can use received compression ratio data to compress input user data using logic circuitry within compress logic 759, if the input user data meets the criterion for compression. The criterion can be provided in the compression ratio data or from table manager 755. Compress logic 759 can provide the compressed data to table manager 755, which can output the compressed data, or can, alternatively or inconjunction with table manager 755, output the compressed data. Compress logic 759 can also provide compression ratio data for subsequent operations associated with compression. Compress logic 759 may be structured to make compression calculations. Table manager 755, in addition to operating with respect to output of read/write compressed data, can operate on read/write mapping data to receive and output the read/write mapping data. Table manager 755 can operate to manage a chained mapping scheme with compressed data as taught herein.

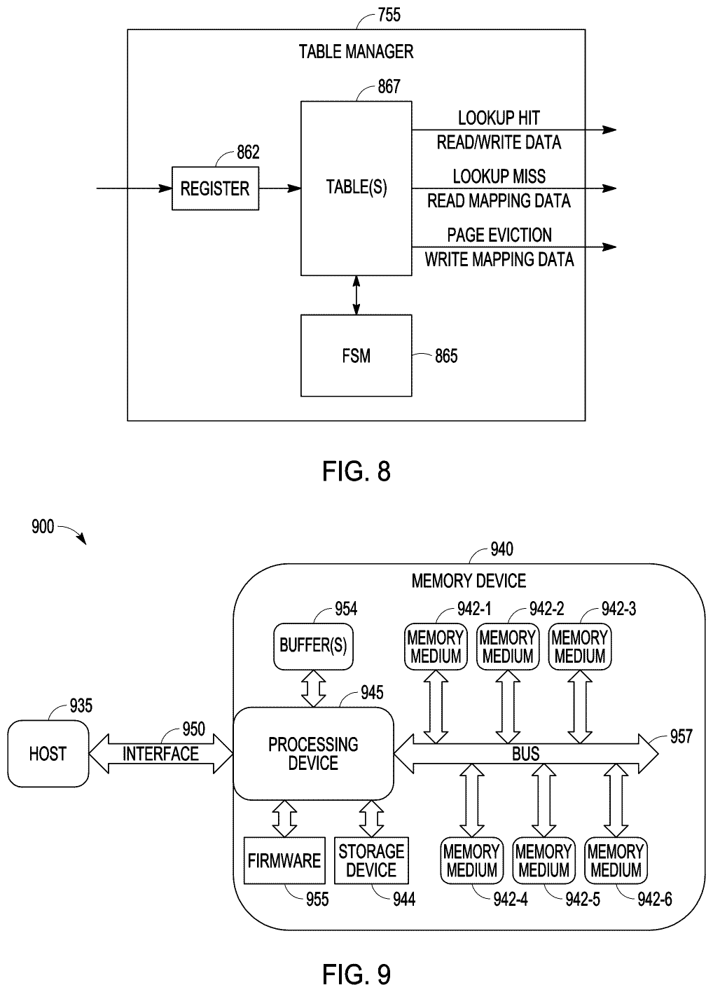

FIG. 8 illustrates an embodiment of an example of table manager 755 of CRM 646 of FIG. 7. Table manager 755 can include register 862. Regsister 862 can be a FIFO structure that can be realized in a number of formats including one or more register structures or one or more other buffering structures that can hold data. Table manager 755 can include one or more tables (table(s)) 867. Table(s) 867 can include a table for mapping and looking-up information on cached data along with updating maps associated with read and write requests. Table(s) 867 can operate with a FSM 865 to make PAs available for use in an invalidation process, including eviction of pages of data from identified memory locations in response to a write operation, as taught herein. Table(s) 867 can include indirection tables for mapping and updating information translating received VA with associated PAs as taught herein. Data that is read frequently can be cached and table(s) 867 can be used to determine if such data is currently part of a read or write (read/write) request. Determination that current data of a read/write request is cached is a hit and determination that current data of a read/write request is not cached is a miss. Table(s) 867 can provide data from looking-up hit data, data from looking-up miss data, and data of page eviction associated with mapping of write operations.

FIG. 9 is a block diagram of an embodiment of example system 900 including a host 935 that operates with a memory device 940 having one or more memory media, where memory device 940 can implement a chained page mapping scheme with compression of user data in applications for which memory device 940 is implemented. The chained page mapping scheme can be implemented using techniques associated with the mapping procedures associated with FIG. 1, the data structures of FIGS. 2 and 3, the methods of FIGS. 4 and 5, and functions associated with the structure of FIGS. 6-8. System 900 and its components can be structured in a number of different arrangements. For example, system 900 can be arranged with a variation of the types of components that comprise host 935, an interface 950, memory device 940, memory media 942-1, 942-2, 942-3, 942-4, 942-5, and 942-6, a processing device 945, one or more buffers (buffer(s)) 954, firmware 955, storage device 944, and a bus 957.

Host 935 is coupled to memory device 940 by interface 950, where host 935 is a host device that can comprise one or more processors, which can vary in type compatible with interface 950 and memory device 940. Memory device 940 can include processing device 945 coupled to memory media 942-1, 942-2, 942-3, 942-4, 942-5, and 942-6 by bus 957, where each memory medium has one or more arrays of memory cells. Memory media 942-1, 942-2, 942-3, 942-4, 942-5, and 942-6 may be realized as memory structures that can be selected from different types of memory. Though six memory media are shown in FIG. 9, memory device 940 can be implemented with more or fewer than six memory media, that is, memory device 940 can comprise one or more memory media. The memory media can be realized in a number of formats including, but not limited to, a plurality of memory dies or a plurality of packaged memory dies.

Processing device 945 can include processing circuitry or be structured as one or more processors. Processing device 945 can be structured as a memory system controller for memory device 940. Processing device 945 can be implemented in a number of different formats. Processing device 945 can include or be structured as one or more types of processors compatible with memory media 942-1, 942-2, 942-3, 942-4, 942-5, and 942-6. Processing device 945 can include processing circuitry that can be structured with a digital signal processor (DSP), an application-specific integrated circuit (ASIC), other type of processing circuit, including a group of processors or multi-core devices, or combinations thereof.

Memory device 940 can comprise firmware 955 having code executable by processing device 945 to at least manage the memory media 942-1, 942-2, 942-3, 942-4, 942-5, and 942-6. Firmware 955 can reside in a storage device of memory device 940 coupled to processing device 945. Firmware 955 can be coupled to the processing device 945 using bus 957 or some other interface on the memory device 940. Alternatively, firmware 955 can reside in processing device 945 or can be distributed in memory device 940 with firmware components, such as but not limited to code, including one or more components in processing device 945. Firmware 955 can include code having instructions, executable by processing device 945, to operate on memory media 942-1, 942-2, 942-3, 942-4, 942-5, and 942-6. The instructions can include instructions to execute operations to store user data as compressed data on one or more of memory media 942-1, 942-2, 942-3, 942-4, 942-5, and 942-6 using a chained mapping scheme as taught herein.

Memory device 940 can include a storage device 944 that can be implemented to provide data or parameters used in maintenance of memory device 940. Storage device 944 can include one or more of a non-volatile memory structure or a RAM. Though storage device 944 is external to processing device 945 in memory device 940 in FIG. 9, storage device 944 may be integrated into processing device 945. Storage device 944 can be coupled to bus 957 for communication with other components of memory device 940. Alternatively, storage device 944 can be coupled with processing device 945 in which processing device 945 handles communications between storage device 944 and other components of the memory device 940. Storage device 944 can be coupled to bus 957 and to processing device 945.

Each of memory media 942-1, 942-2, 942-3, 942-4, 942-5, and 942-6, firmware 955, storage device 944, and other memory structures of memory device 940 are implemented as machine-readable medium. Non-limiting examples of machine-readable media can include solid-state memories, optical media, and magnetic media. Specific examples of non-transitory machine-readable media can include non-volatile memory, such as semiconductor memory media (e.g., EPROM, EEPROM) and flash memory devices; magnetic disks, such as internal hard disks and removable disks; magneto-optical disks; and compact disc-ROM (CD-ROM) and digital versatile disc-read only memory (DVD-ROM) disks.

Firmware 955, storage device 944, or other components of memory device 940 can include a mapping table having an entry location to associate a VP with a PA of a first stripe of compressed data of the VP. The mapping table can be structured similar to mapping table 105 of FIG. 1. Processing device 945 can be implemented as controller to write a second physical address of a set of physical addresses into the first stripe in the physical memory, where the second physical address corresponds to a second stripe of the compressed data and to sequentially write remaining stripes of multiple stripes to the physical memory, beyond the second stripe, where each of the remaining stripes contains a physical address at which to write a subsequent stripe in the sequential writing until writing a last stripe of the compressed data of the virtual page corresponding to the virtual address.

Firmware 955, storage device 944, or other components of memory device 940 can have instructions, executable by processing device 945, to operate on user data to store the user data in one or more of memory media 942-1, 942-2, 942-3, 942-4, 942-5, and 942-6 in a compressed format. Firmware 955, storage device 944, or other components of memory device 940 can have instructions, executable by processing device 945, to operate on compressed user data to read and generate uncompressed user data from one or more of memory media 942-1, 942-2, 942-3, 942-4, 942-5, and 942-6.

Processing device 945 can execute instructions stored on one or more components in memory device 940, which instructions, when executed by processing device 945, cause memory device 940 to perform operations. The operations can include operations of method 400, method 500, methods similar to method 400 or method 500, associated with such methods, and functions of structures associated with FIGS. 6-8. The operations can include operations to read data from physical memory of one or more of memory media 942-1, 942-2, 942-3, 942-4, 942-5, and 942-6, where the data is stored in compressed format.

The operations can include accessing an indirection table based on a VA received in a read request to memory device 940 from host 935. The indirection table can be accessed by loading the indirection table if the indirection table is not cached. The indirection table can be located in one or more of buffer(s) 954, firmware 955, storage device 944, or processing device 945.

The operations can include reading a first stripe of multiple stripes of compressed data from a physical memory of memory device 940, where the multiple stripes of compressed data correspond to the read request. Each stripe of the multiple stripes can have, but is not limited to, a size of 64 bytes. The first stripe can be read from the physical memory at a PA listed in the indirection table corresponding to the VA. The operations can include reading, from the first stripe, a PA of a next stripe of the multiple stripes of compressed data and reading the next stripe of compressed data from the physical memory corresponding to the PA of the next stripe. The reading of the next stripe includes reading a PA of a subsequent stripe of the multiple stripes of compressed data. The operations can include sequentially reading remaining stripes of the multiple stripes, beyond the next stripe. Each of the remaining stripes is read from a PA obtained while reading a previous stripe in the sequential reading. The compressed data read from the multiple stripes is uncompressed. The uncompressed data can be provided to host 935.

Operations executed using processing device 945 can include placing additional read requests for data corresponding to the virtual address in a progress list. The progress list can be located in one or more of buffer(s) 954, firmware 955, storage device 944, or processing device 945.

Operations executed using processing device 945 can include, while reading the first stripe of compressed data, reading the PA of the next stripe through pins of a memory subsystem of memory device 940. The pins can be pins used for functions different from transferring user data. The pins can be, but are not limited to, DMI pins. Operations can include uncompressing the compressed data after all the compressed data of the multiple stripes of compressed data is read from the physical memory of the memory device. Operations can include copying uncompressed data to one or more caches of the memory device or to one or more read buffers of the memory device, which uncompressed data has been generated after reading all the multiple stripes from the physical memory. The one or more read buffers can be included in buffer(s) 954.

Processing device 945 can execute instructions stored on one or more components in memory device 940, which instructions, when executed by processing device 945, cause memory device 940 to perform operations. The operations can include operations to write data to physical memory of one or more of memory media 942-1, 942-2, 942-3, 942-4, 942-5, and 942-6 in compressed format.

The operations can include accessing an indirection table based on a VA received in a write request to memory device 940 from host 935. The indirection table can be accessed by loading the indirection table for processing. Alternatively, the indirection table can be accessed in a cache, where the indirection table includes a first PA corresponding to the VA.

Operations executed using processing device 945 can include compressing data of a user page size corresponding to the write request. The user page size can be, but is not limited to, 4 KB. Operations can include obtaining PAs of a physical memory from a FSM of memory device 940 based on size of the compressed data. The PAs define locations of multiple stripes to store the compressed data in the physical memory. Operations can include updating the indirection table with a first PA of the PAs, where the first PA corresponds to a first stripe of the compressed data.

Operations executed using processing device 945 can include writing a second PA of the PAs into the first stripe in the physical memory, where the second PA corresponds to a second stripe of the compressed data. Operations include sequentially writing remaining stripes of the multiple stripes to the physical memory beyond the second stripe. Each of the remaining stripes contains a PA at which to write a subsequent stripe in the sequential writing until writing a last stripe of the compressed data of the VP corresponding to the VA.

Operations executed using processing device 945 can include, prior to compressing the data corresponding to the write request, passing a PA mapped to the VA in the accessed indirection table to the FSM and obtaining PAs of a chain of stripes associated with the PA mapped to the VA in the accessed indirection table by the FSM. The FSM can traverse through the chain of stripes and identify a PA in each stripe of the chain other than the last stripe of the chain. Operations can include the FSM freeing locations for future write requests.

Operations executed using processing device 945 can include writing the first stripe, the second stripe, and the remaining stripes with a PA of a subsequent stripe of the compressed data in reserved bit locations in each stripe. Operations can include writing the PA of a subsequent stripe in a previous stripe using pins of a memory subsystem of memory device 940. The pins can be pins used for functions different from transferring user data. The pins can be, but are not limited to, DMI pins.

The following are example embodiments of systems, devices, and methods, in accordance with the teachings herein.

An example memory device 1 can comprise a mapping table having an entry location to associate a VP with a PA of a first stripe of data of the VP, the data arranged in multiple stripes in a physical memory of the memory device, and a controller, responsive to the data of the VP being compressed data, to load information about a second stripe of the compressed data into extra locations in the first stripe, the extra locations being locations in the first stripe different from locations for compressed data of the VP.

An example memory device 2 can include features of example memory device 1 and can include the information about the second stripe including the PA of the second stripe.

An example memory device 3 can include features of any of the preceding example memory devices and can include the controller arranged to load information about a third stripe of compressed data into extra locations in the second stripe, the extra locations in the second stripe being allocations different from allocations for the compressed data of the VP.

An example memory device 4 can include features of example memory device 3 and any of the preceding example memory devices and can include the information about the third stripe including the PA of the third stripe.

An example memory device 5 can include features of any of the preceding example memory devices and can include a free space manager to make available PAs to write data from a host to a memory subsystem of the memory device.

An example memory device 6 can include features of any of the preceding example memory devices and can include a compute express link (CXL) type 3 memory device.

In an example memory device 7, any of the memory devices of example memory devices 1 to 6 may include memory devices incorporated into an electronic apparatus further comprising a host processor and a communication bus extending between the host processor and the memory device.

In an example memory device 8, any of the memory devices of example memory devices 1 to 7 may be modified to include any structure presented in another of example memory device 1 to 7.

In an example memory device 9, any apparatus associated with the memory devices of example memory devices 1 to 8 may further include a machine-readable storage device configured to store instructions as a physical state, wherein the instructions may be used to perform one or more operations of the apparatus.

In an example memory device 10, any of the memory devices of example memory devices 1 to 9 may be operated in accordance with any of the below example methods 1 to 20.

An example method 1 of operating a memory device can comprise accessing an indirection table based on a VA received in a read request to the memory device from a host device; reading a first stripe of multiple stripes of compressed data from a physical memory of the memory device, the multiple stripes of compressed data corresponding to the read request, the first stripe read from the physical memory at a PA listed in the indirection table corresponding to the VA; reading, from the first stripe, a PA of a next stripe of the multiple stripes of compressed data; reading the next stripe of compressed data from the physical memory corresponding to the PA of the next stripe, including reading a PA of a subsequent stripe of the multiple stripes of compressed data; sequentially reading remaining stripes of the multiple stripes, beyond the next stripe, each of the remaining stripes read from the physical memory at a PA obtained while reading a previous stripe in the sequential reading; and uncompressing the compressed data read from the multiple stripes.

An example method 2 of operating a memory device can include features of example method 1 of operating a memory device and can include placing additional read requests for data corresponding to the virtual address in a progress list.

An example method 3 of operating a memory device can include features of any of the preceding example methods of operating a memory device and can include, while reading the first stripe of compressed data, reading the PA of the next stripe through pins of a memory subsystem of the memory device, the pins used for functions different from transferring user data.

An example method 4 of operating a memory device can include features of any of the preceding example methods of operating a memory device and can include uncompressing the compressed data after all the compressed data of the multiple stripes of compressed data is read from the physical memory of the memory device.

An example method 5 of operating a memory device can include features of any of the preceding example methods of operating a memory device and can include copying uncompressed data, generated after reading the multiple stripes from the physical memory, to one or more caches of the memory device or to one or more read buffers of the memory device.

An example method 6 of operating a memory device can include features any of the preceding example methods of operating a memory device and can include accessing the indirection table includes loading the indirection table if the indirection table is not cached.

An example method 7 of operating a memory device can include features of any of the preceding example methods of operating a memory device and can include each stripe of the multiple stripes having a size of 64 bytes.

In an example method 8 of operating a memory device, any of the example methods 1 to 7 of operating a memory device may be performed in operating an electronic apparatus further comprising a host processor and a communication bus extending between the host processor and the memory device.

In an example method 9 of operating a memory device, any of the example methods 1 to 8 of operating a memory device may be modified to include operations set forth in any other of example methods 1 to 8.

In an example method 10 of operating a memory device, any of the example methods 1 to 9 of operating a memory device may be implemented at least in part through use of instructions stored as a physical state in one or more machine-readable storage devices.

An example method 11 of operating a memory device can include features of any of the preceding example methods 1 to 10 of operating a memory device and can include performing functions associated with any features of example memory devices 1 to 11 of operating a memory device.

An example method 12 of operating a memory device can comprise accessing an indirection table based on a virtual address received in a write request to the memory device from a host device; compressing data of a user page size corresponding to the write request, generating compressed data; obtaining PAs of a physical memory from a free space manager of the memory device based on size of the compressed data, the PAs defining locations of multiple stripes to store the compressed data in the physical memory; updating the indirection table with a first PA of the PAs, the first PA corresponding to a first stripe of the compressed data; writing a second PA of the PAs into the first stripe in the physical memory, the second PA corresponding to a second stripe of the compressed data; sequentially writing remaining stripes of the multiple stripes to the physical memory, beyond the second stripe, each of the remaining stripes containing a PA at which to write a subsequent stripe in the sequential writing until writing a last stripe of the compressed data of a VP corresponding to the virtual address.

An example method 13 of operating a memory device can include features of example method 12 of operating a memory device and can include, prior to compressing the data corresponding to the write request, passing a PA mapped to the virtual address in the accessed indirection table to the free space manager, obtaining PAs of a chain of stripes associated with the PA mapped to the virtual address in the accessed indirection table by the free space manager traversing through the chain and identifying a PA in each stripe of the chain other than the last stripe of the chain; and freeing locations for future write requests.

An example method 14 of operating a memory device can include features of any of the preceding example methods 12 to 13 of operating a memory device and can include writing the first stripe, the second stripe, and the remaining stripes with a PA of a subsequent stripe of the compressed data being written includes writing the PA in each stripe in reserved bit locations in each stripe.

An example method 15 of operating a memory device can include features of any of the preceding example methods 12 to 14 of operating a memory device and can include accessing the indirection table to include loading the indirection table for processing.

An example method 16 of operating a memory device can include features of any of the preceding example methods 12 to 15 of operating a memory device and can include writing the PA of a subsequent stripe in a previous stripe using pins of a memory subsystem of the memory device, the pins used for functions different from transferring user data.

An example method 17 of operating a memory device can include features of any of the preceding example methods 12 to 16 of operating a memory device and can include accessing the indirection table includes accessing the indirection table in a cache, the indirection table including a first PA corresponding to the virtual address.

An example method 18 of operating a memory device can include features of any of the preceding example methods 12 to 17 of operating a memory device and can include the user page size being 4 KB.

In an example method 19 of operating a memory device, any of the example methods 12 to 18 of operating a memory device may be performed in operating an electronic apparatus further comprising a host processor and a communication bus extending between the host processor and the memory device.

In an example method 20 of operating a memory device, any of the example methods 12 to 19 of operating a memory device may be modified to include operations set forth in any other of example methods 12 to 19 of operating a memory device.

In an example method 21 of operating a memory device, any of the example methods 12 to 20 of operating a memory device may be implemented at least in part through use of instructions stored as a physical state in one or more machine-readable storage devices.

An example method 22 of operating a memory device can include features of any of the preceding example methods 12 to 21 of operating a memory device and can include performing functions associated with any features of example memory device 1 to 11.

An example method 23 of operating a memory device can include features of any of the preceding example methods 1 to 11 of operating a memory device and example methods 12 to 22 of operating a memory device and can include performing functions associated with any features of example memory device 1 to 11.

An example machine-readable storage device storing instructions, that when executed by one or more processors, cause a machine to perform operations, can comprise instructions to perform functions associated with any features of example memory devices 1 to 11 or perform methods associated with any features of example methods 1 to 11 of operating a memory device and example methods 12 to 23 of operating a memory device.

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. It is to be understood that the above description is intended to be illustrative, and not restrictive, and that the phraseology or terminology employed herein is for the purpose of description.

What is claimed is:

1. A memory device comprising:
a mapping table having an entry location to associate a virtual page with a physical address of a first stripe of data of the virtual page, the data arranged in multiple stripes in a physical memory of the memory device; and
a controller, responsive to the data of the virtual page being compressed data, to load information about a second stripe of the compressed data into extra locations in the first stripe, the extra locations being locations in the first stripe different from locations for compressed data of the virtual page.

2. The memory device of claim 1, wherein the information about the second stripe includes the physical address of the second stripe.

3. The memory device of claim 1, wherein the controller is arranged to load information about a third stripe of compressed data into extra locations in the second stripe, the extra locations in the second stripe being locations different from locations for the compressed data of the virtual page.

4. The memory device of claim 3, wherein the information about the third stripe includes the physical address of the third stripe.

5. The memory device of claim 1, wherein the memory device includes a free space manager to make available physical addresses to write data from a host to a memory subsystem of the memory device.

6. The memory device of claim 1, wherein the memory device is a compute express link (CXL) type 3 memory device.

7. A method of operating a memory device, the method comprising:
accessing an indirection table based on a virtual address received in a read request to the memory device from a host device;
reading a first stripe of multiple stripes of compressed data from a physical memory of the memory device, the multiple stripes of compressed data corresponding to the read request, the first stripe read from the physical memory at a physical address listed in the indirection table corresponding to the virtual address;
reading, from the first stripe, a physical address of a next stripe of the multiple stripes of compressed data;
reading the next stripe of compressed data from the physical memory corresponding to the physical address of the next stripe, including reading a physical address of a subsequent stripe of the multiple stripes of compressed data;
sequentially reading remaining stripes of the multiple stripes, beyond the next stripe, each of the remaining stripes read from the physical memory at a physical address obtained while reading a previous stripe in the sequential reading; and
uncompressing the compressed data read from the multiple stripes.

8. The method of claim 7, wherein the method includes placing additional read requests for data corresponding to the virtual address in a progress list.

9. The method of claim 7, wherein the method includes, while reading the first stripe of compressed data, reading the physical address of the next stripe through pins of a memory subsystem of the memory device, the pins used for functions different from transferring user data.

10. The method of claim 7, wherein the method includes uncompressing the compressed data after all the compressed data of the multiple stripes of compressed data is read from the physical memory of the memory device.

11. The method of claim 7, wherein the method includes copying uncompressed data, generated after reading the multiple stripes from the physical memory, to one or more caches of the memory device or to one or more read buffers of the memory device.

12. The method of claim 7, wherein accessing the indirection table includes loading the indirection table if the indirection table is not cached.

13. The method of claim 7, wherein each stripe of the multiple stripes has a size of 64 bytes.

14. A method of operating a memory device, the method comprising:
accessing an indirection table based on a virtual address received in a write request to the memory device from a host device;
compressing data of a user page size corresponding to the write request, generating compressed data;
obtaining physical addresses of a physical memory from a free space manager of the memory device based on size of the compressed data, the physical addresses defining locations of multiple stripes to store the compressed data in the physical memory;
updating the indirection table with a first physical address of the physical addresses, the first physical address corresponding to a first stripe of the compressed data;
writing a second physical address of the physical addresses into the first stripe in the physical memory, the second physical address corresponding to a second stripe of the compressed data;
sequentially writing remaining stripes of the multiple stripes to the physical memory, beyond the second stripe, each of the remaining stripes containing a physical address at which to write a subsequent stripe in the sequential writing until writing a last stripe of the compressed data of a virtual page corresponding to the virtual address.

15. The method of claim 14, wherein the method includes:
prior to compressing the data corresponding to the write request, passing a physical address mapped to the virtual address in the accessed indirection table to the free space manager;
obtaining physical addresses of a chain of stripes associated with the physical address mapped to the virtual address in the accessed indirection table by the free space manager traversing through the chain and identifying a physical address in each stripe of the chain other than the last stripe of the chain; and
freeing locations for future write requests.

16. The method of claim 14, wherein writing the first stripe, the second stripe, and the remaining stripes with a physical address of a subsequent stripe of the compressed data being written includes writing the physical address in each stripe in reserved bit locations in each stripe.

17. The method of claim 14, wherein accessing the indirection table includes loading the indirection table for processing.

18. The method of claim 14, wherein the method includes writing the physical address of a subsequent stripe in a previous stripe using pins of a memory subsystem of the memory device, the pins used for functions different from transferring user data.

19. The method of claim 14, wherein accessing the indirection table includes accessing the indirection table in a cache, the indirection table including a first physical address corresponding to the virtual address.

20. The method of claim 14, wherein the user page size is 4 KB.
